(19) United States
(12) Patent Application Publication
(10) Pub. No.: US 2009/0135296 A1
(43) Pub. Date: May 28, 2009

(54) IMAGING MODULE PACKAGE

(75) Inventors: YING-CHENG WU, Taipei Hsien (TW); PANG-JUNG LIU, Taipei Hsien (TW); CHIEN-CHENG YAO, Taipei Hsien (TW); SHIH-MIN LO, Taipei Hsien (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Taipei Hsien (TW)

(21) Appl. No.: 12/013,929

(22) Filed: Jan. 14, 2008

(30) Foreign Application Priority Data
Nov. 27, 2007 (CN) 200710202721.0

(51) Int. Cl. H04N 5/225

(52) U.S. Cl. 348/373

(57) ABSTRACT

An exemplary imaging module package includes a housing, an imaging sensor module, and a lens module. The housing includes a first chamber and a second chamber coaxially aligned with the first chamber. The imaging sensor module is positioned within the first chamber and includes a substrate, an imaging sensor, a plurality of passive components and a plurality of soldering pads. The soldering pads connect the imaging sensor to the substrate. The passive components are mounted to the substrate and wholly disposed below the imaging sensor. The lens module is positioned within the second chamber of the housing.

### BACKGROUND

1. Technical Field

The present invention relates to imaging technology and, particularly, to an imaging module package having a compact configuration.

2. Description of Related Art

An imaging sensor module generally comprises a substrate, an imaging sensor, and a plurality of passive components mounted to the substrate. The passive components are substantially disposed at a same level with the imaging sensor, and surround the imaging sensor. The imaging sensor is physically and electrically connected to the substrate via a plurality of soldering pads between the imaging sensor and the substrate. The passive components are separated from the imaging sensor for facilitating heat dissipation and avoiding EMI. A total area of the imaging sensor module is larger than the actual area occupied by the imaging sensor and the passive components.

Typically, digital still cameras are desired to be compact for portability. Thus, it is desirable that an imaging module package using the imaging sensor module be compact. However, the imaging sensor module is bulky, because the substrate must have a large enough top surface for supporting both the imaging sensor and the passive components thereon and occupies a large space of the imaging module package.

What is needed, therefore, is an imaging module package which has a compact configuration.

### SUMMARY

According to a present embodiment, an imaging module package includes a housing, an imaging sensor module, and a lens module. The housing includes a first chamber and a second chamber coaxially aligned with the first chamber. The imaging sensor module is positioned within the first chamber and includes a substrate, an imaging sensor, a plurality of passive components and a plurality of soldering pads. The soldering pads connect the imaging sensor to the substrate. The passive components are mounted to the substrate and wholly disposed below the imaging sensor. The lens module is positioned within the second chamber of the housing.

Other advantages and novel features will be drawn from the following detailed description of at least one embodiment, when considered in conjunction with the attached drawings.

### BRIEF DESCRIPTION OF THE DRAWINGS

FIG. 1 is a cross-sectional view of an imaging sensor module, according to a present first embodiment.

FIG. 2 is a cross-sectional view of an imaging module package using the imaging sensor module of FIG. 1.

FIG. 3 is a cross-sectional view of an imaging sensor module, according to a present second embodiment.

### DETAILED DESCRIPTION OF THE EMBODIMENTS

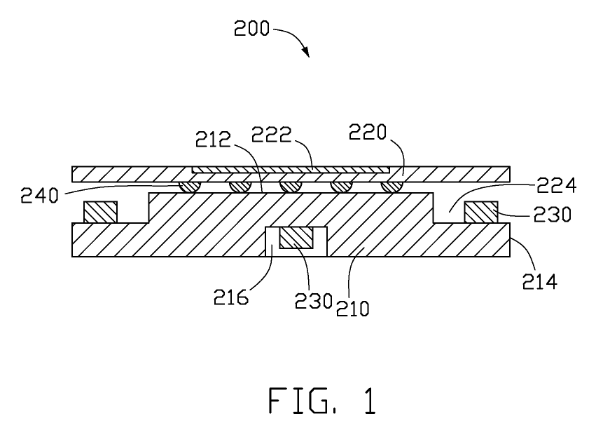

Referring to FIG. 1, an imaging sensor module 200 according to a present first embodiment is illustrated. The imaging sensor module 200 comprises a substrate 210, an imaging sensor 220, and a plurality of passive components 230. The imaging sensor 220 is physically and electrically connected to the substrate 210 via a plurality of soldering pads 240 between the imaging sensor 220 and the substrate 210. The passive components 230 are mounted to the substrate 210 and are wholly disposed below the imaging sensor 220.

The substrate 210 comprises a raised portion 212 at a center thereof and at least two shoulders 214 disposed at a circumference of the substrate 210 to surround the raised portion 212. At least one recess 216 is defined in the substrate 210 below the raised portion 212.

The imaging sensor 220 may be a charge coupled device (CCD) imaging sensor or a complementary metal oxide semiconductor (CMOS) imaging sensor. The imaging sensor 220 comprises a central sensing area 222. The soldering pads 240 are arrayed on the raised portion 212 to connect the imaging sensor 220 to the raised portion 212 of the substrate 210. Gaps 224 are defined between the imaging sensor 220 and the shoulders 214.

The passive components 230 may be resistors, capacitors, or inductors. The passive components 230 are respectively secured in the gaps 224 and the at least one recess 216 without protruding from the corresponding gaps 224 and the at least one recess 216. The area occupied by the imaging sensor module 200 is determined by the area of the substrate 210, which is substantially equal to the area of the imaging sensor 220.

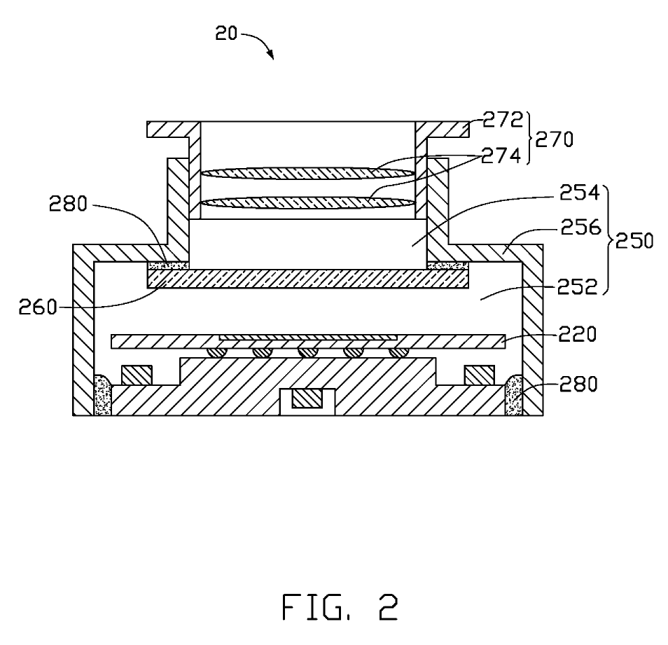

Referring to FIG. 2, an imaging module package 20 using the imaging sensor module 200 is illustrated. The imaging module package 20 further comprises a housing 250, a transparent cover 260, a lens module 270 and adhesive 280. The housing 250 comprises a first chamber 252, a second chamber 254, and a connecting plate 256 between the first and second chambers 252, 254. The first chamber 252 is generally larger than the second chamber 254 and coaxially aligned with the second chamber 254. The imaging sensor module 200 and the transparent cover 260 are positioned within the first chamber 252 via the adhesive 280. The transparent cover 260 is adhered to a bottom surface of the connecting plate 256 and the imaging sensor 220 is disposed below the transparent cover 260. The lens module 270 is positioned within the second chamber 254 and disposed above the transparent cover 260. The lens module 270 comprises a lens barrel 272 secured within the second chamber 254 and lenses 274 carried within the lens barrel 272. For the imaging module package 20, the first chamber 252 has a cross-sectional area which is merely slightly larger than the area of the imaging sensor 220, space that would normally be additionally occupied by the passive components 230 is saved. Thus, the imaging module package 20 has a compact configuration.

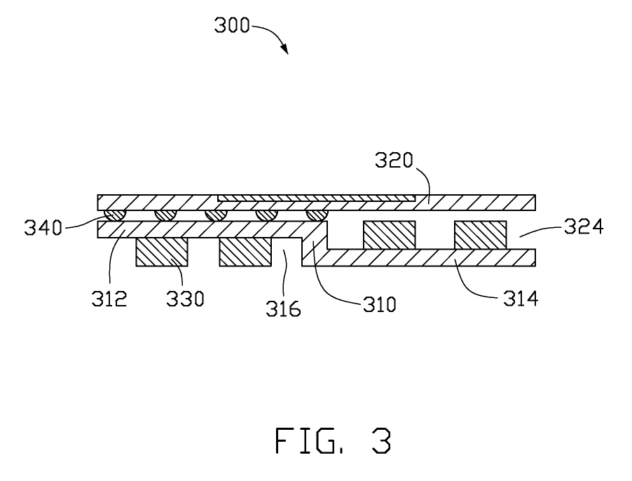

Referring to FIG. 3, an imaging sensor module 300 according to a second embodiment is illustrated. The imaging sensor module 300 comprises a substrate 310, an imaging sensor 320, and a plurality of passive components 330. The imaging sensor 320 is physically and electrically connected to the substrate 310 via a plurality of soldering pads 340 between the imaging sensor 320 and the substrate 310. The passive components 330 are mounted to the substrate 310 and wholly disposed below the imaging sensor 320.

The substrate 310 comprises a raised portion 312 at a side thereof and a shoulder 314 at an opposite side thereof. A recess 316 is defined in the substrate 310 below the raised portion 312. The soldering pads 340 are arrayed on the raised portion 312 to connect the imaging sensor 220 to the raised portion 312 of the substrate 310. A gap 324 is defined between the imaging sensor 320 and the shoulder 314. The passive components 330 are respectively secured in the gap 324 and the recess 316 without protruding out of the gap 324 and the recess 316. Similar to the first embodiment, the largest area of the imaging sensor module 300 is determined by the area of the substrate 210, which is substantially equal to the area of the imaging sensor 320. Other features of the imaging module package 300 are similar to that of the imaging module package 200, and can be referenced from the description of the first embodiment.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. An imaging module package comprising:
a housing comprising a first chamber and a second chamber coaxially aligned with the first chamber;
an imaging sensor module positioned within the first chamber, the imaging sensor module comprising a substrate, an imaging sensor, a plurality of passive components, and a plurality of soldering pads, the soldering pads connecting the imaging sensor to the substrate, the passive components being mounted to the substrate and wholly disposed below the imaging sensor; and
a lens module positioned within the second chamber.

2. The imaging module package as claimed in claim 1, wherein the substrate comprises a raised portion and at least two shoulders surrounding the raised portion, and wherein the soldering pads are disposed between the raised portion and the imaging sensor.

3. The imaging module package as claimed in claim 2, wherein a recess is defined below the raised portion and gaps are defined between the imaging sensor and the shoulders, and wherein the passive components are secured in the recess and the gaps.

4. The imaging module package as claimed in claim 1, wherein the substrate comprises a raised portion at a side thereof and a shoulder at an opposite side thereof, and wherein the soldering pads are disposed between the raised portion and the imaging sensor.

5. The imaging module package as claimed in claim 4, wherein a recess is defined between the raised portion and a gap is defined between the imaging sensor and the shoulder, and wherein the passive components are secured in the recess and the gap.

6. The imaging module package as claimed in claim 1, further comprising an adhesive positioning the imaging sensor module within the first chamber.

7. The imaging module package as claimed in claim 1, further comprising a transparent cover between the lens module and the imaging sensor module.

8. The imaging module package as claimed in claim 7, wherein the housing comprises a connecting plate between the first and second chamber, and wherein the transparent cover is positioned to a bottom surface of the connecting plate.

9. The imaging module package as claimed in claim 8, wherein the transparent cover is adhered to the bottom surface of the connecting plate.

10. The imaging module package as claimed in claim 1, wherein the lens module comprises a lens barrel secured within the second chamber and lenses carried within the lens barrel.

11. The imaging module package as claimed in claim 1, wherein the area of the substrate is substantially equal to the area of the imaging sensor.

12. The imaging module package as claimed in claim 1, wherein the first chamber has a cross-sectional area, which is slightly larger than the area of the imaging sensor.
